(19) United States
(12) Patent Application Publication
(10) Pub. No.: US 2010/0332080 A1
(43) Pub. Date: Dec. 30, 2010

(54) METHOD AND APPARATUS FOR PARKING ASSISTANCE

(76) Inventor: HONG BAE, FARMINGTON HILLS, MI (US)

Correspondence Address: HONG BAE, 29703 CITATION TRIANGLE #10203, FARMINGTON HILLS, MI, 48331, US

(21) Appl. No.: 12/705,563

(22) Filed: Feb. 12, 2010

Related U.S. Application Data
(60) Provisional application No. 61/220,277, filed on Jun. 25, 2009.

(51) Int. Cl. G06F 7/00; B62D 15/02; G01S 3/80; G01V 1/18; B60Q 1/00

(52) U.S. Cl. 701/42; 367/118; 367/178; 340/439; 340/435

(57) ABSTRACT

A method of providing assistance to a driver for parking a vehicle includes detection of a space and a location of the vehicle for vehicle parking. The method determines a feasibility for parking the vehicle into the space based on the space; calculates a parking path based on the space and the location; generates a constant target position of a steering wheel based on the parking path; generates a first human machine interface (HMI) signal that instructs the driver to turn the steering wheel based on the target position, wherein the first HMI signal is generated when the vehicle is not moving; monitors a steering wheel angle of the vehicle including comparing the steering wheel angle with the constant target position, and detecting that the steering wheel angle reaches a proximity of the target position. The method also includes generating a second HMI signal that instructs the driver to hold the steering wheel, wherein the second HMI signal is generated when the steering wheel angle has reached the proximity of the target position; generating a vehicle motion command after the steering wheel angle is held steadily according to the second HMI signal; and generating a third HMI signal based on the vehicle motion command.

### CROSS-REFERENCE TO RELATED APPLICATIONS

This application claims the benefit of a U.S. Provisional Application No. 121/220,277 filed on Jun. 25, 2009. The disclosure of the above application is incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of driver assistant systems. More particularly, the present invention is in the technical field of parking assist devices.

Parallel parking can be a challenge to many drivers along a busy city street. Drivers with less than well established skill often encounter difficulty in maneuvering the vehicle into the scarcely available parking space. The challenge may include providing appropriate amount of steering angle at an appropriate location of the vehicle relative to the available space defined by the two already-parked vehicles. Drivers may rely on an automatic parking system to accomplish the desired parallel parking. These automatic parking systems are based on pre-installed hardware devices from the factory that may include automatic steering mechanism and control devices for throttle and brake. Therefore, such factory systems are only available on new and expensive vehicles, and cannot be easily retro-fitted to existing vehicles without an extremely high expense for the modifications.

While automatic parking systems can automatically maneuver the vehicle into the desired parking space for parallel parking, a parking assist system may also provide driver with instructions on steering wheel, braking and accelerator pedals activities to perform the desired parallel parking maneuver. However, when the parking assist system gives steering instructions that require the driver to follow the constantly steering commands closely, the steering instructions by itself impose a difficult challenge to the driver. In addition, having to operate throttle and brake makes following the steering instructions even harder. Failure to follow the instructions close enough may result in a failure of successful completion of the parking maneuver.

### BRIEF SUMMARY OF THE INVENTION

In one feature, the present invention describes a method of providing assistance to a driver for parking a vehicle. The method includes detection of a space and a location of the vehicle for vehicle parking. The method determines feasibility for parking the vehicle into the space based on the space detected. The method also includes calculating a parking path based on the space and the location and generating a constant target position of a steering wheel based on the parking path. The method generates a first human machine interface (HMI) signal that instructs the driver to turn the steering wheel based on the target position. The first HMI signal is generated when the vehicle is not moving. The method monitors steering wheel angle of the vehicle. The monitoring includes comparison of the steering wheel angle with the constant target position, and detection of the steering wheel angle reaching proximity of the target position. The method also generates a second HMI signal that instructs the driver to hold the steering wheel. The second HMI signal is generated when the steering wheel angle has reached the proximity of the target position. The method generates a vehicle motion command after the steering wheel angle is held steadily according to the second HMI signal. The method generates a third HMI signal that instructs the driver to move the vehicle. The third HMI signal is generated based on the vehicle motion command.

In another embodiment, the present invention describes a parking assist system. The parking assist system provides parking instructions to a driver of a vehicle, and includes a central processing module, a space determining module, a parking path calculating module, a progress monitoring module and a user interface control module. The central processing module receives vehicle signals and detects a space for parking, and determines a relative position between the space and the vehicle. The space determining module determines a feasibility of whether the space is large enough for parking. The parking path calculating module computes a parking path. The parking path is calculated based on the feasibility, the size of the space and the relative position. The parking path calculating module generates a target steering position command based on the parking path. The target steering position command is piecewise constant. The parking path calculating module also generates a vehicle motion command. The vehicle motion command is generated based on a steering motion status of a steering wheel. The progress monitoring module monitors a steering wheel position and the target steering position command. The progress monitoring module determines whether the steering wheel position is within a predetermined error bound of the target steering position command. The progress monitoring module monitors a steering wheel motion to determine whether the steering wheel is held steadily. The progress monitoring module also generates the steering motion status based on the steering wheel motion and the steering wheel position. The user interface control module generates a first human-machine interface (HMI) signal. The first HMI signal is generated based on the piecewise constant target steering position command. The user interface control module generates a second HMI signal. The second HMI signal is generated when the steering wheel position is within the error bound of the target steering position. The user interface control module also generates a third HMI signal. The third HMI signal is generated based on the vehicle motion command.

### BRIEF DESCRIPTION OF THE SEVERAL VIEWS OF THE DRAWING

FIG. 1 shows limitations of a prior art parking assist system, and advantages of the present invention.

FIG. 2 shows a motor vehicle equipped with a parking assist device according to the present invention;

FIG. 3A shows one embodiment of a Central Processing Module of the parking assist system according to the principles of this invention;

FIG. 3B shows another embodiment of the Central Processing Module with wireless communication to sensors and driver interface.

FIG. 3C shows yet another embodiment of the Central Processing Module connected with a vehicle signal interface device.

FIG. 4 shows a situation of the beginning of parking space measurement;

FIG. 5 shows a situation of the space measurement sensor sensing the available space;

FIG. 6 shows a situation of the beginning of parking maneuver;

FIG. 7 shows a situation of the parking vehicle in the middle of a series of parking maneuvers;

FIG. 8 shows a situation of the parking vehicle nearing the end of a parking sequence;

FIG. 9 shows a situation of back-in parking;

FIG. 10 shows the steering angle instructions and corresponding forward-and-backward movement of the vehicle to be followed by the driver;

FIG. 11 shows the steering angle instructions and error bounds;

FIG. 12 shows the steering angle instructions and corresponding vehicle speed followed by the driver, aided by more instructions via HMI devices;

FIG. 13 shows a flow chart for the steps of a method for parking assistance according to an embodiment of the invention.

FIG. 14 shows a flow chart for the steps of a method of an overall sensing module and algorithm according to an embodiment of the invention;

FIG. 15 shows a flow chart of the steps of a method for an execution stage according to an embodiment of the invention.

### DETAILED DESCRIPTION OF THE INVENTION

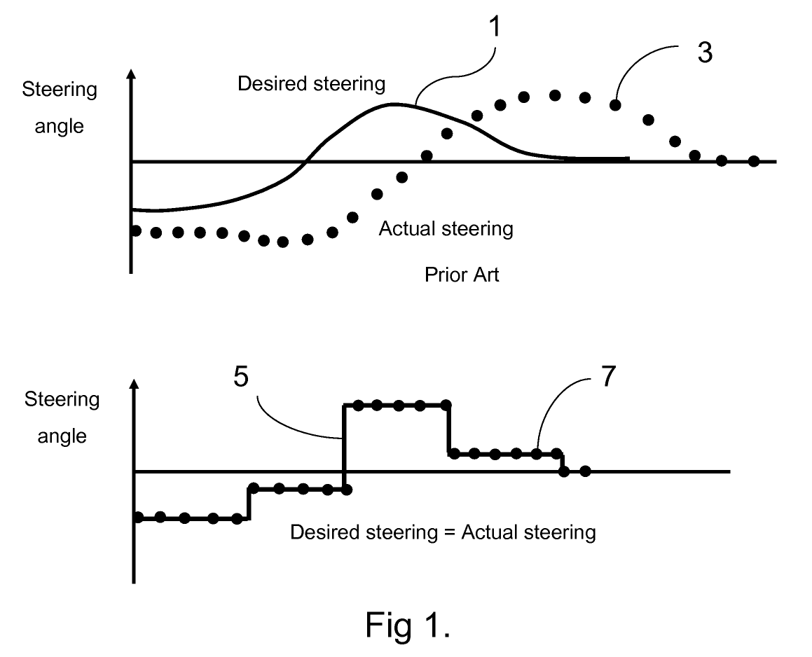

Referring to FIG. 1, the difficulty associated with a prior art parking assist system is shown. In a prior park assist system, the driver may be asked to follow instructions that change continuously. However, following continually changing steering command is very difficult, especially when the driver is also instructed to control throttle and/or brake as well. A parking assist system may have an automated steering mechanism that controls the steering wheel without requiring any input from the driver. To the contrary, when the steering wheel command is discrete as described in this invention, it is much easier to follow by the driver, and no automated steering mechanism is necessary. A discrete steering wheel command may include piecewise constant steering wheel positions for the driver to follow in an instructed sequence according to the principles of this invention. The piecewise constant steering wheel positions may have magnitudes ranging from zero to a full-lock position. When the magnitude of the steering wheel position is zero, the steering wheel is at its center position and the vehicle front wheels are positioned to point to the straight forward direction. When the steering wheel position is at its full-lock position, the vehicle front wheels point to a maximum angle away from the straight-forward direction.

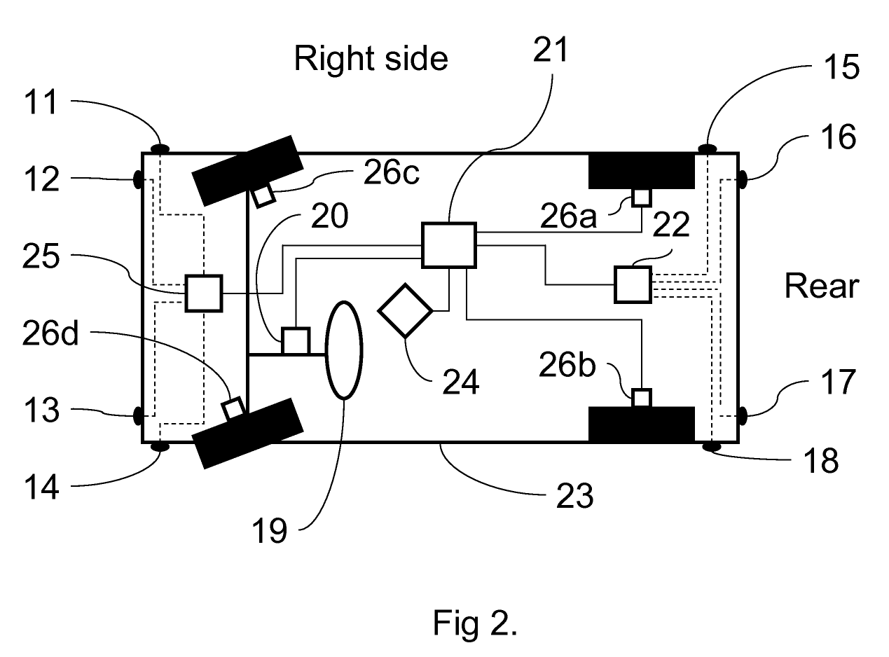

Referring to FIG. 2 there is shown a motor vehicle equipped with a Central Processing Module 21 for assisted parking of a motor vehicle 23 into a parking space. The Central Processing Module 21 can also be used to implement the method according to the present invention.

The motor vehicle 23 may contain parking distance sensors 11 and 15, at the front and rear of the vehicle, respectively, at the passenger side, pointing to the right. Parking distance sensors 14 and 18 may be installed at the front and rear of the vehicle, respectively, at the driver side, pointing to the left. In addition, the parking distance sensors 12 and 13 are pointing forward while the sensors 16 and 17 are facing backward. The parking distance sensors in the general area of the front of a vehicle communicate with the front sensor processing module 25 while the rear sensors are connected to the rear sensor processing module 22. The Central Processing Module 21 collects information from the sensor processing modules 22 and 25 as well as the Steering wheel angle sensor 20, attached to the steering wheel 19. The processing modules 22 and 25 can be incorporated into the Central Processing Module 21 in one embodiment. A Human Machine Interface (HMI; such as visual, auditory or tactile output) device 24 informs the driver of the steering and throttle and/or brake commands generated by the Central Processing Module 21. The Central Processing Module 21 also monitors how the driver is doing and changes parking instructions accordingly. For illustrative purpose, the two sensors 15 and 18 are used for measuring distance to other objects around the vehicle 23 to monitor the right and left sides of the vehicle 23, respectively. Utilization of the other sensors 11, 12, 13, 14, 16, and 17 according to the principles of this invention are understood by skilled artisans in the field of parking assist systems. For example, sensors 16 and 17 may be used to monitor vehicle backing-up maneuver to avoid collision with an object when vehicle is moving backwards. Wheel speed sensors 26a, 26b, 26c, and 26d may be used to keep track of the position of the vehicle 23.

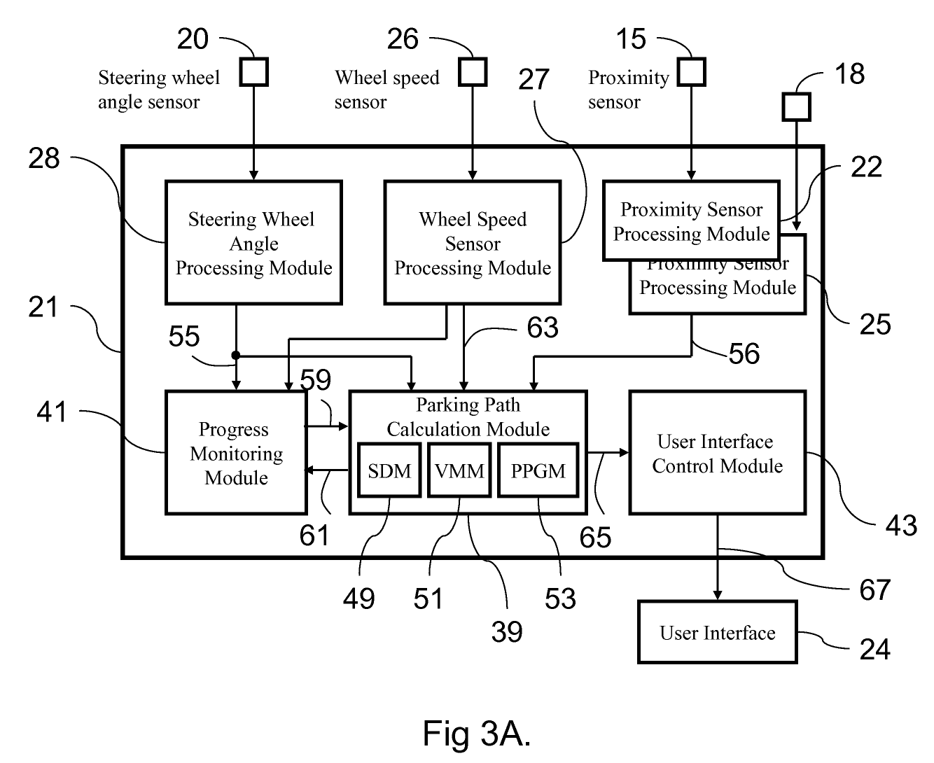

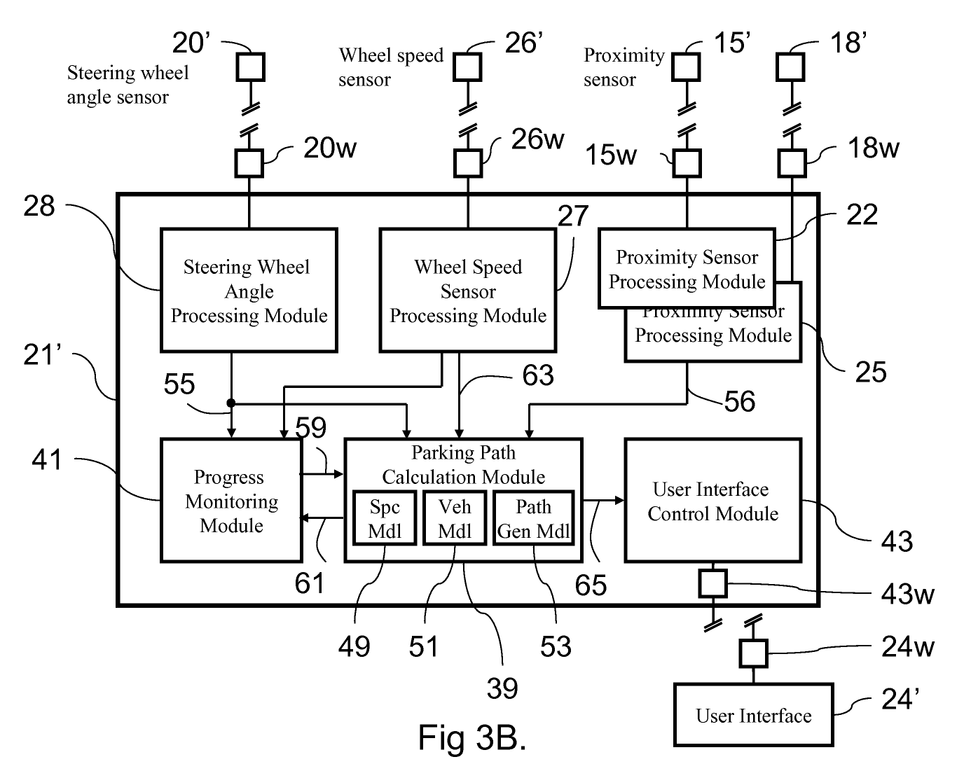

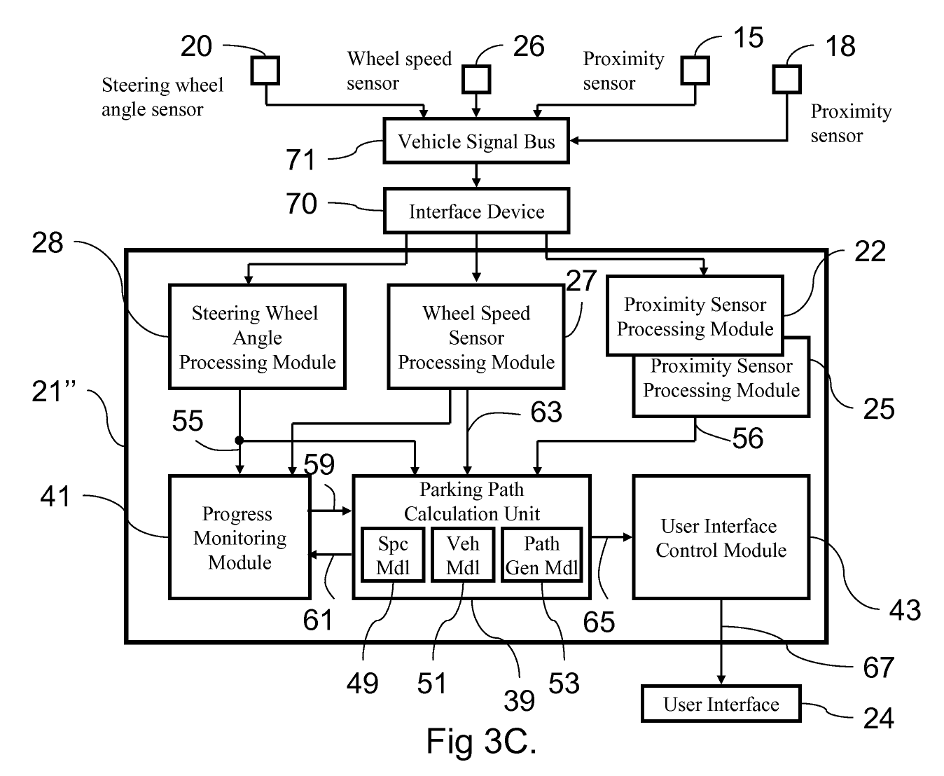

Referring now to FIG. 3A, the Central Processing Module 21 is shown with more details. Wheel speed sensor signals generated by speed sensors 26 are processed by the wheel speed sensor processing Module 27, and the processed wheel speed signals 63 are sent to the Parking Path Calculating Module 39. Similarly, steering sensor signal generated by the Steering wheel angle sensor are processed by the Steering Wheel Angle Processing Module 28, and the processed steering wheel angle signal 55 is sent to the Progress Monitoring Module 41, and is also sent to the Parking Path Calculating Module 39. Proximity Sensor Processing Modules 22 and 25 receive signals from the front and rear proximity sensors 11 through 18. For illustrative purpose only signals 15 and 18 are shown. The Proximity Sensor Processing Modules 22 and 25 send processed signals to the Parking Path Calculating Module 39. The Parking Path Calculating Module 39 also sends a preliminary desired path signal 61 to the Progress Monitoring Module 41.

The Progress Monitoring Module 41 monitors a steering wheel position and the target steering position command to determine whether the steering wheel position is within proximity of the target steering position. The Progress Monitoring Module 41 may monitor a steering wheel motion to determine whether the steering wheel is held steadily. The Progress Monitoring Module 41 may also generate a steering motion status signal based on the proximity and the steering wheel motion to indicate whether the steering wheel has reached proximity of the target steering position, or the steering wheel is held steadily, respectively. The steering motion status is one of SET and RESET. The steering motion status is reset when the steering wheel has reach the proximity of the target steering position and the steering wheel is held steadily; otherwise the steering motion status is set. The Progress Monitoring Module 41 may send the steering motion status to the Parking Path Calculating Module 39 via signal 59. The Parking Path Calculating Module 39 may generate a signal 65 that includes instructions to the driver. The instructions may include a vehicle motion command to instruct the driver to move forward or backward, or to instruct the driver to stop the vehicle. The vehicle motion command is communicated to the driver when the steering motion status is reset. The Parking Path Calculating Module 39 signals the User Interface Control Module 43 to send signals to the User Interface device or devices 24, based on the signal 65. The Parking Path Calculating Module 39 may include a Space Determining Module 49 that determines whether a space is large enough for parking, a Vehicle Model Module 49 that includes a vehicle model for computation of parking maneuver path, and a Path Generation Module 53 that generates the desired vehicle path for parking maneuvers.

FIG. 3B illustrates another embodiment of the Central Processing Module 21′. The Central Processing Module 21′ may include a wireless receiver 20w that receives the steering wheel angle signal generated by a wireless steering wheel angle sensor 20′, a wireless wheel speed receiver 26w that receives wheel speed signal generated by a wireless speed signal sensor 26′, wireless proximity receivers 15w and 18w that receive proximity signals generated by wireless proximity sensors 15′ and 18′, respectively, and a wireless transmitter 24w that transmits HMI signals to a wireless user interface 24′. The Central Processing Module 21′ may include a wireless interface device 43w connected to the User Interface Control Module 43.

Referring now to FIG. 3C, a vehicle signal interface device 70 is shown to be connected with the Central Processing Module 21″. In this embodiment, sensor signals generated by sensors installed on the vehicle, such as the steering wheel angle sensor 20, the wheel speed sensor 26 and the proximity sensors 15 and 18, may be directed to a vehicle signal bus 71. The vehicle signal interface device 70 may be connected to the vehicle signal bus 71 to receive the sensor signals to be processed by the Central Processing Module 21″.

The Central Processing Module disclosed in FIG. 3A, 3B or 3C may be implemented by a hand-held electronic device that includes a microprocessor or microcomputer and a signal interface circuit that receives vehicle signals via wired or wireless signal interface. In one embodiment, the hand-held electronic device may be a personal data assistant (PDA). In another embodiment, the hand-held electronic device may be a smart phone.

Using wireless receivers to receive sensor signals for the Central Processing Module 21 allows the Central Processing Module 21 to be a separate and independent module from vehicle manufacture. Likewise, using the vehicle signal interface device 70 to receive vehicle signals for the Central Processing Module 21 allows the Central Processing Module 21 to be a separate and independent module from the vehicle. In either embodiment or any alternatives according to the principles of this invention, the Central Processing Module 21 can be installed to the vehicle by a user after purchase of the vehicle. A universal serial bus (USB) may be used to further interface the wireless signal or vehicle signals obtained from the vehicle signal bus to the Central Processing Module.

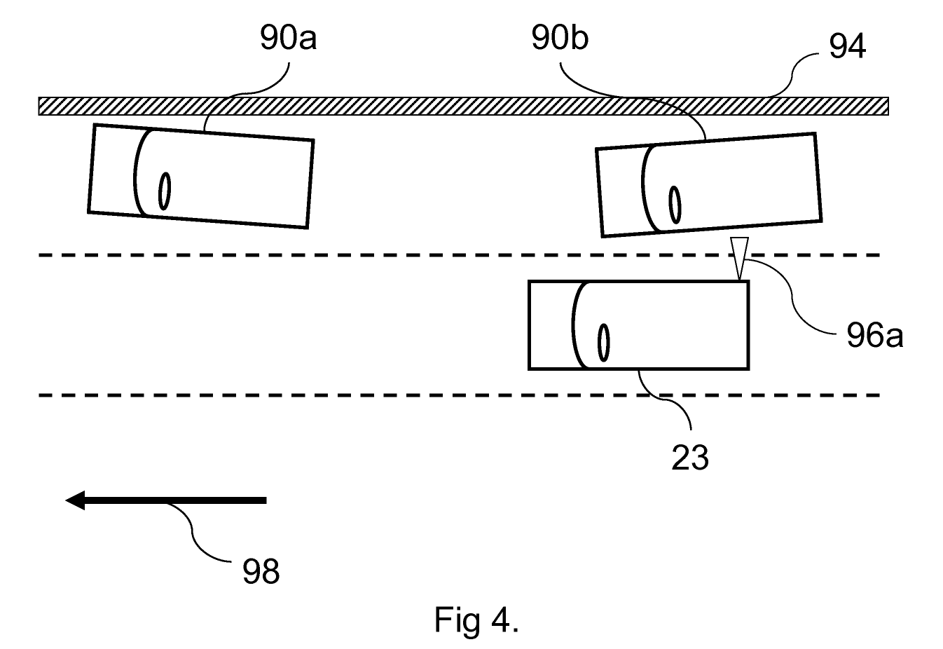

Referring now to FIG. 4, the driver in the motor vehicle 23 with a parking assist device in the present invention is driving along in the direction of 98, looking for a parking space. Once a potential parking space between parked vehicles 90a and 90b is spotted by the driver, the driver may activate the parking assist device in the present invention (or, alternatively, the devices activates automatically) and then drives slowly and passes the potential parking space. The distance measuring device starts measuring the length and depth of the space. In one embodiment, the distance measuring device consists of an ultrasonic sensor at the location of sensor 15 in FIG. 2 and the Proximity Sensor Processing Module 22. The sensor 15 emits appropriate waves 96a, whose return waves are used to compute a distance from the side of the vehicle in the Proximity Sensor Processing Module 22. For illustrative purpose, the normal direction 98 of traffic is to the left of the vehicle 23 in FIG. 4.

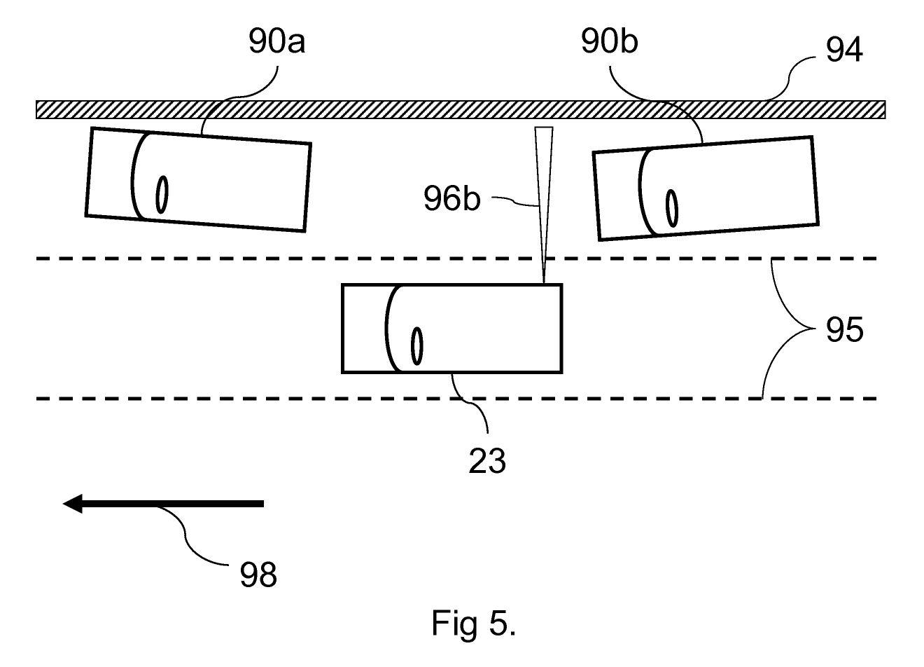

Referring now to FIG. 5, the vehicle 23 with the device in the present invention passes the empty parking space between the parked vehicles 90a and 90b. A parking distance sensor, for example, the proximity sensor 15 and a sensor processing module, for example, the proximity sensor processing module 22, measure the empty space by the sensing lobe 96b and appropriate processing of the signal. In the meantime, the vehicle 23 stays within the lane markings 95.

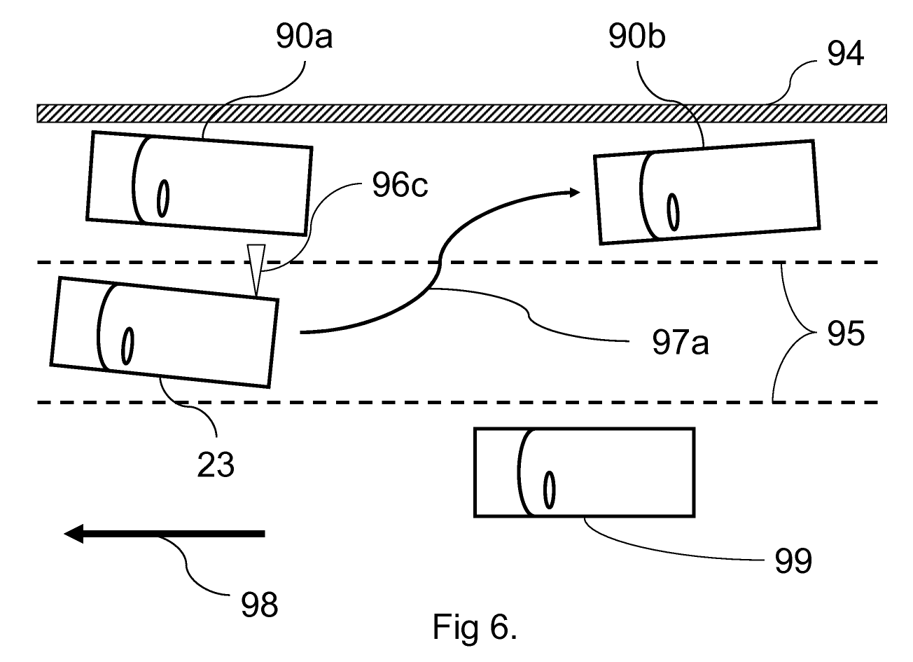

Referring now to FIG. 6, the motor vehicle 23 stops after the parking distance sensor and the sensor processing module determine from the sensing lobes 96a, 96b, and 96c and other information (for example, location from GPS or vehicle to vehicle communication) that there is indeed enough space for parking, given the dimension of the vehicle 23 (called “feasibility test” step). The rear Proximity Sensor Processing Module 22 and the Central Processing Module 21 in FIG. 2 also keep track of where the motor vehicle 23 is in relation to the parked vehicles 90a and 90b. Based on this information, the Central Processing Module 21 determines a relative position between the vehicle 23 and the parked vehicles 90a, 90b. The Central Processing Module 21 calculates a (or multiple) potential parking path 97a that the driver needs to follow in terms of appropriate steering angle and vehicle forward and backward movement trajectories or instructions. The Central Processing Module 21 may calculate the parking path 97a based on the feasibility of parking, the size of the space and the relative position of the vehicles. The Central Processing Module 21 may utilize the wheel speed signals 26 to keep track of the location of the vehicle during the parking maneuver.

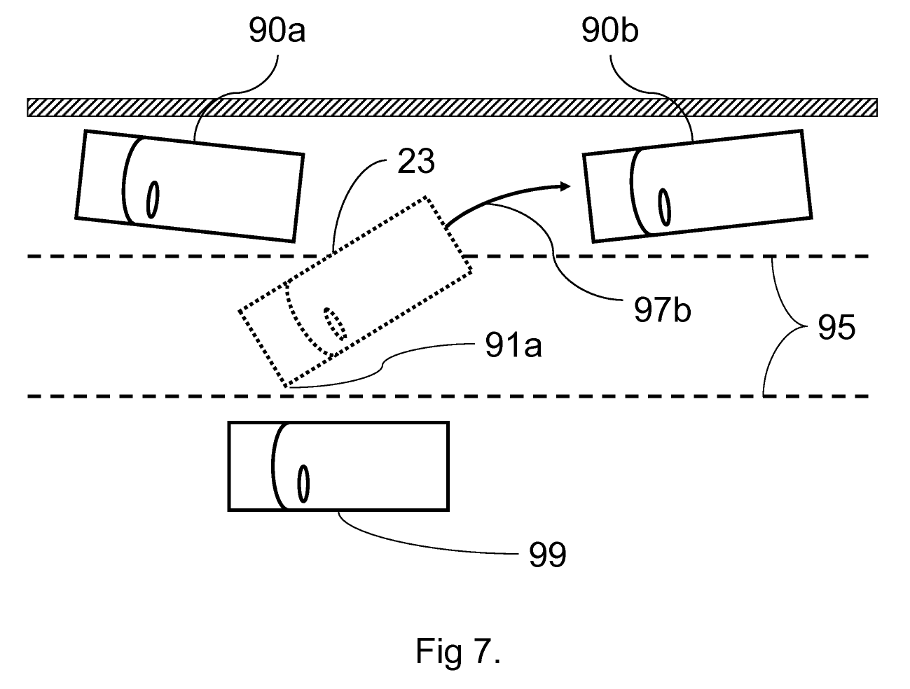

Referring now to FIG. 7, when the Central Processing Module 21 in FIG. 2 calculates parking path 97b, the algorithm in the Central Processing Module 21 also evaluates where the motor vehicle 23 is in relation to other traffic on the road such as the vehicle 99 in the adjacent lane. For example, when the vehicle 23 attempts to park into a space that is to the right (passenger side) of the vehicle 23, the front left corner 91a might cross into the adjacent lane, which might cause a collision with traffic (vehicle 99) in the lane. The algorithm in the Central Processing Module 21 calculates the parking path 97b so that the motor vehicle 23 stays within the lane markings 95 at all times when the driver follows the parking commands from the Central Processing Module 21. Therefore, the present invention ensures safety in the sense that parking maneuvers will not interfere with other traffic in the adjacent lanes.

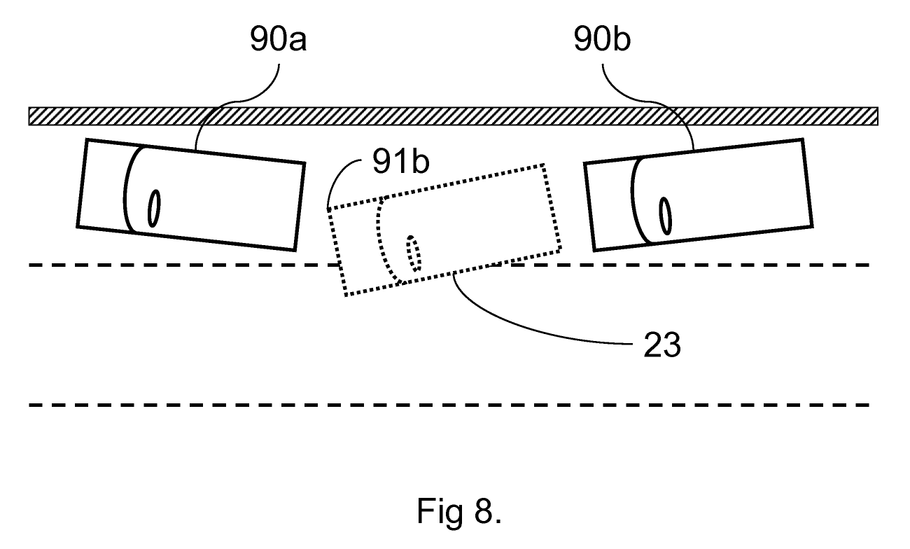

Referring now also to FIG. 8 which shows a continued parking action from FIG. 7, when the Central Processing Module 21 calculates the parking path 97b, the unit also makes sure that the front right corner 91b clears the parked vehicle 90a safely.

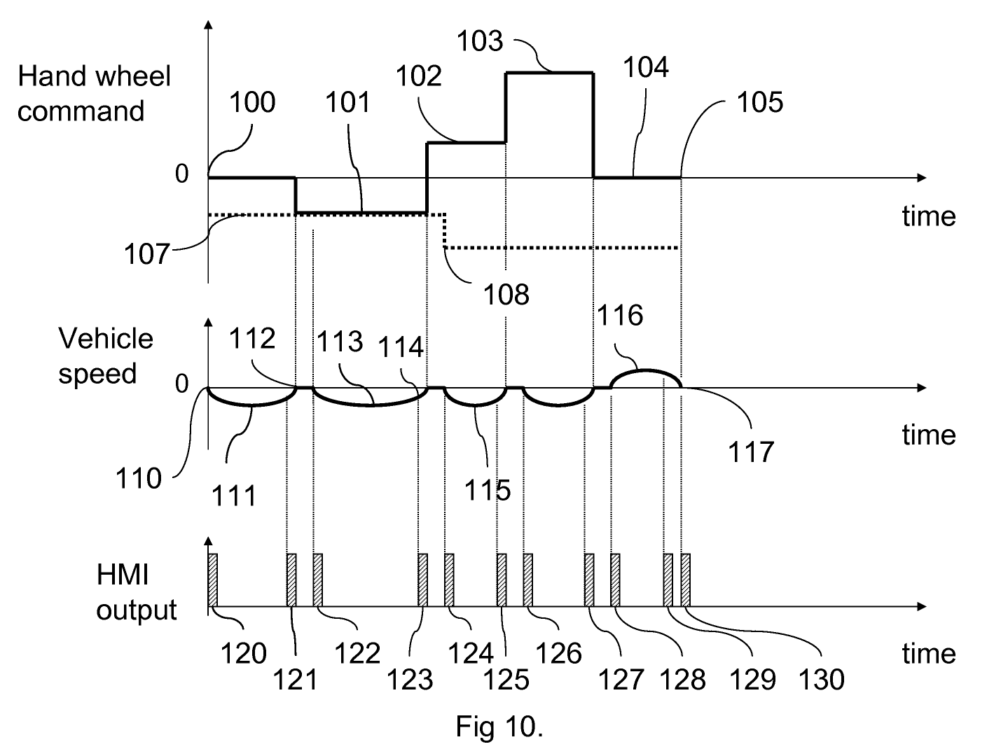

In one embodiment additional constraints can be easily incorporated to generate the steering wheel instructions. For example, referring to FIG. 6, the Central Processing Module 21 and the sensors may sense where the vehicle is relative to the parked vehicles, and how the vehicle is oriented. Given the information, the position of the vehicle 23 relative to the lane markings 95 is known. This information forms another constraint in the steering wheel instructions in that the front left corner 91a of the vehicle 23 should be within the lane marking 95 at all times so that the vehicle 23 will not hit the passing vehicle 99. Based on the vehicle model and where the vehicle is, the algorithm imposes the constraint so that the front left corner 91a stays with the lane marking 95 in FIG. 6. Referring to FIG. 10, the first constraint on the discrete steering instruction corresponds to the line 107. Referring to the same figure, when the steering wheel can be turned more as constraints relax or disappear, the steering wheel turning constraints expand to the line 108.

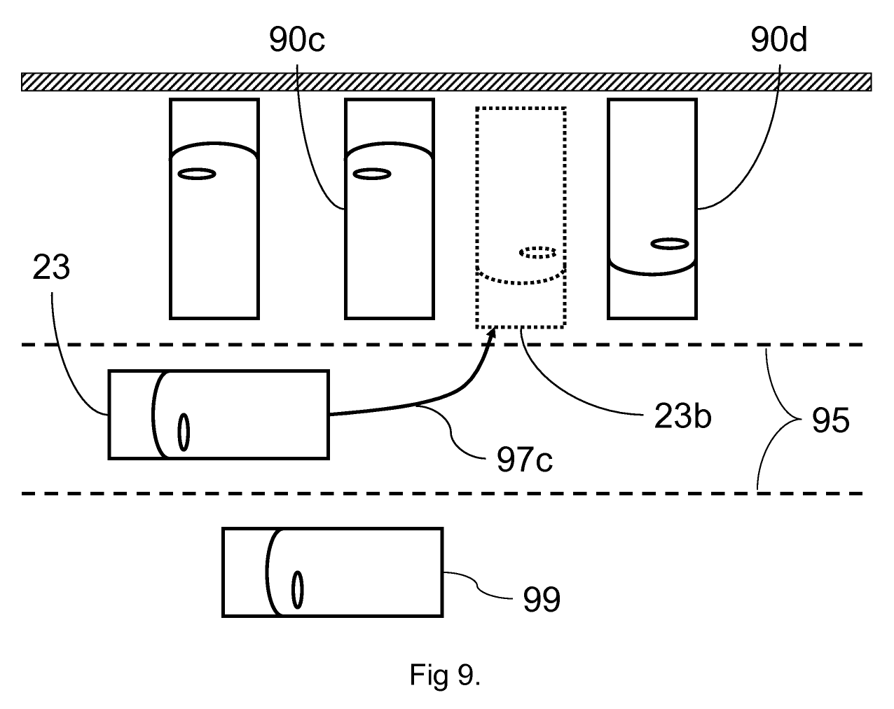

Referring now to FIG. 9, when desired as indicated by the driver or automatically detected, the Central Processing Module 21 in FIG. 2 calculates parking path 97c for back-in (back-up, or 90 degree) parking, following the steps similar to the previous description. As the driver drives by the parked vehicles 90c and 90d, the Proximity Sensor Processing Module 22 and the Central Processing module perform a feasibility test to determine whether the space scanned is enough for parking. The rear Proximity Sensor Processing Module 22 and the Central Processing Module 21 in FIG. 2 also keep track of where the motor vehicle 23 is in relation to the parked vehicles 90c and 90d. Based on this information, the Central Processing Module 21 calculates a (or multiple) potential parking path 97c that the driver needs to follow in terms of appropriate steering angle and vehicle forward and backward movement trajectories or instructions. The Central Processing Module 21 may utilize the wheel speed signals 26 to keep track on the location of the vehicle during the parking maneuver. In a manner similar to the previous descriptions, piecewise constant steering instructions are generated accordingly and the drive may get the corresponding instructions via HMI devices.

Referring now to FIG. 10, the first plot labeled “Hand Wheel Command” shows an example of a series of piecewise constant hand wheel angle commands in discrete steps. Each piece of the hand wheel angle commands may have a magnitude range from 0 to a full-lock steering angle. The HMI device 24 may communicate the magnitude to the driver during the parking maneuver. In this example, when the Central Processing Module 21 commences parking assist mode and starts monitoring the vehicle and environment parameters, the first hand wheel angle command 100 starts at 0 degrees, corresponding to the position of the motor vehicle 23 in FIG. 6, with the vehicle generally pointing straight forward. At this point, an HMI device 24 in FIG. 2 sends a queue at time 120 (for example, a voice may say through a speaker, “keep the steering wheel steady and start backing up” or corresponding information may be displayed on a screen). The driver then starts backing up until time 121 when the HMI device 24 instructs the driver to stop (“Stop” or a beep via auditory means or a visual display). When the vehicle 23 comes to a complete stop, as monitored by the Central Processing Module 21, the unit 21 sends another command of a discrete steering angle 101 (which may include “turn the steering wheel to the left until a beep” or “turn the steering to the right by 30 degrees”) and waits until time 122 while monitoring whether the steering wheel has been turned accordingly. Upon completion of turning at time 122, the driver follows the instruction and starts backing up while the progress is monitored by the Central Processing Module 21. In one embodiment, there may not be a separate acknowledgement for the completion of steering wheel turning. The issuance of the backup instruction is an indication of the successful completion of turning of the steering wheel. The driver then backs up while holding the steering wheel steady at a constant angle 101. This process continues with more discrete steering instructions 102, 103 and 104. The dotted lines 107 and 108 indicate the maximum angles to which the steering wheel can be turned while avoiding any contact with objects such as parked vehicles surrounding the vehicle 99. The process repeats and the driver may have to turn the steering wheel a few times. Over the course of a series of a particular parking maneuver, the driver may be instructed to move forward so that enough space is left in the front and back of the vehicle 23 from other parked vehicles 90a and 90b. In such a case, the driver is instructed to straighten out the steering wheel, hand wheel angle 104. At the completion of turning at time 128, the driver is instructed to pull forward. The final command at time 129 instructs the driver to stop. At time 130, the parking maneuver is complete.

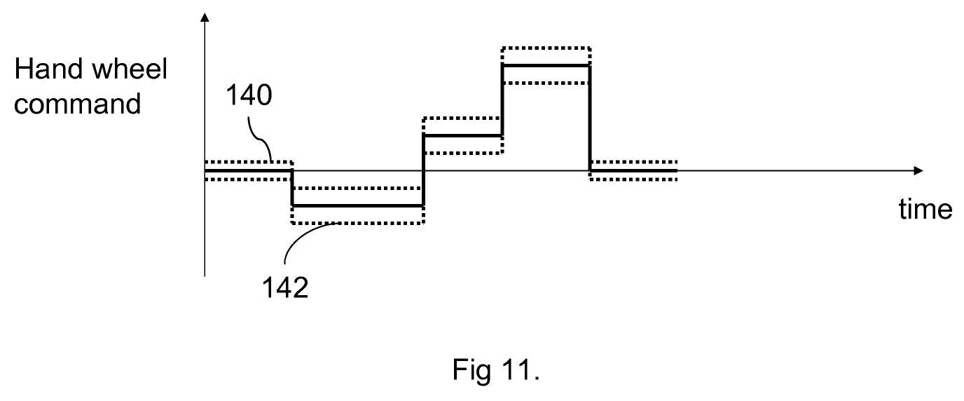

Referring to FIG. 11, the Central Processing Module 21 may generate hand wheel instructions that include acceptable ranges defined by upper error bounds 140 and lower error bounds 142 so that, as long as the driver follows the turning instructions within the upper and lower bounds, the vehicle 23 in FIG. 6 can be parked without the need to start over. The algorithm in the Central Processing Module 21 constantly monitors these allowed error bounds as well as the progress of parking internally. If the driver makes mistakes and turns the steering wheel beyond the error bounds and moves the vehicle 23, the Central Processing Module 21 evaluates the situation. If the vehicle can still be parked from the current location and orientation of the vehicle into the original parking space (another “feasibility test”), the Central Processing Module 21 calculates a new parking path similar to the parking path 97a in FIG. 6, and instructs the driver accordingly. The driver may not be aware of this internal step. If the vehicle 23 cannot be parked into the parking space from the current location and orientation of the vehicle, the Central Processing Module 21 instructs the driver to start over from a feasible starting point (typically the previous original staring point).

One advantage of this invention is the ability to easily include error bounds so that the steering turn instructions can be “loosely” followed, and parking still be completed. For example, referring to FIG. 11, the potential error (e.g., 10 degrees) on the steering wheel turning execution can be explicitly included. In such a case, when the driver turns the steering wheel by 120 degrees when the instruction called for 110 degrees, the initiated parking sequence will still be valid and the vehicle 23 can be parked into the space without starting over.

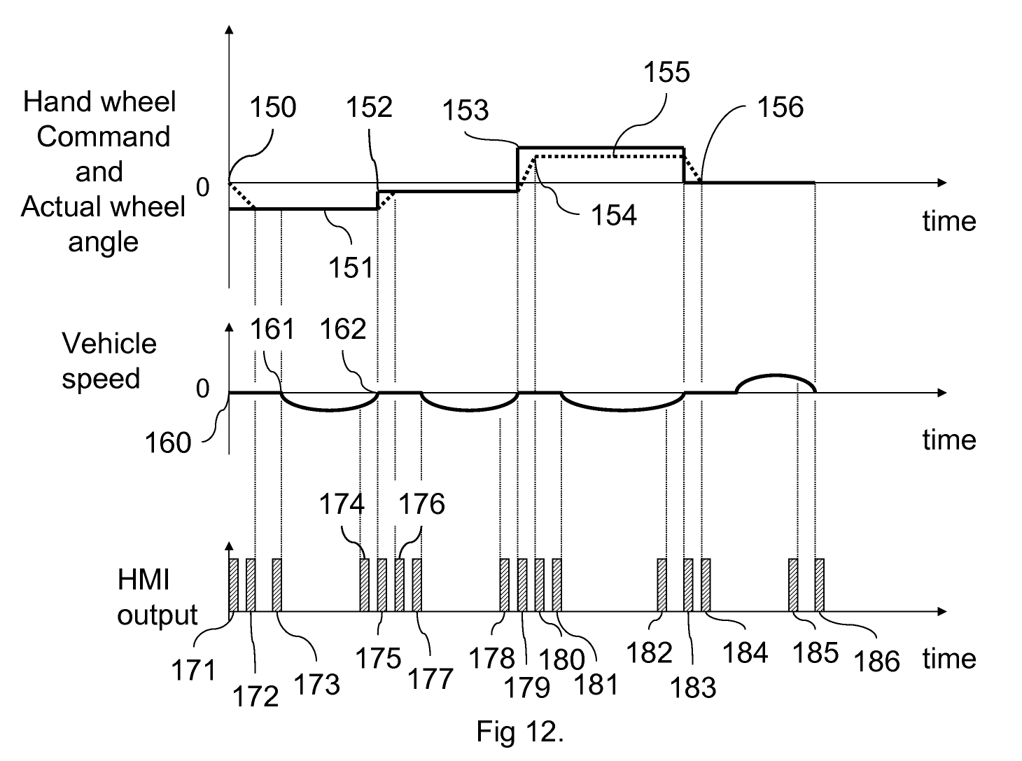

Referring to FIG. 12, another embodiment of steering turning and vehicle movement commands and corresponding HMI outputs are shown. In the first plot, in addition to the steering wheel command, the actual wheel angle over time is shown. The actual wheel angle changes as the driver turns the steering wheel, and is measured by the Steering wheel angle sensor 20 in FIG. 2. Since a human driver turns the steering wheel according to the commands through an HMI device and its progress monitored by the Central Processing Module 21, the actual steering wheel angles may be different from the commands to be followed. For example, the actual steering angle takes time (e.g., on the order of a second or two) to reach the commanded angle 151 from the starting angle 150. In other words, the actual steering angle usually ramps up to the target steering angle instead of reaching the target steering angle instantaneously. At other times, the driver may not quite turn the steering wheel to the commanded angle 154, ending at the actual angle 155. If the difference between the angles 154 and 155 is within the error bounds (similar to the upper bounds 140 and lower bounds 142 shown in FIG. 11), as monitored and evaluated by the Central Processing Module 21, the current sequence of the parking maneuvers can still be used. If the difference is too large, then a new sequence of parking maneuvers can be computed by the Central Processing Module 21.

In one embodiment, the HMI device 24 may communicate the steering instruction to the driver using tactile feedback. For example, the HMI device 24 may cause the steering wheel to vibrate when the steering wheel is turned to the proximity of the target steering position within predetermined error bounds.

In the last plot, HMI outputs over time are shown. In this embodiment, the first HMI output 171, if an auditory device is used, says, “turn the steering wheel to the left by 30 degrees,” or “turn the steering wheel to the left until a beep.” In the meantime, the vehicle is stationary. As the driver turns the steering wheel and the steering wheel angle reaches the instructed angle as monitored by the Steering wheel angle sensor 20 and the Central Processing Module 21, another HMI output 172 informs the driver that the target steering angle has been reached by saying “Stop turning the steering wheel” or by a simple beep. The time when HMI output 172 is issued is based on the speed of the steering wheel turning so that, by the time the driver stops turning, the target angle is reached within a pre-determined bound caused by human error. Then, HMI output 173 instructs the driver to back up, saying “Hold the steering wheel steady and start backing up slowly.” The driver then starts moving backwards. When the vehicle approaches a stop point, HMI output 174 says “Stop the vehicle”, which brings to vehicle to a stop 162. At that point, HMI output 175 says “turn the steering wheel to the right by 20 degrees,” or “turn the steering wheel to the right until a beep,” corresponding to the hand wheel command 152. As the steering angle approaches the target angle 152, another HMI output 176 says “Stop turning the steering wheel angle” or issues a beep. HMI output 177 instructs the driver to back up and similar maneuvers are followed as previously described. The Central Processing Module 21 monitors the progress, and issues corrective instructions if necessary until the parking is deemed complete.

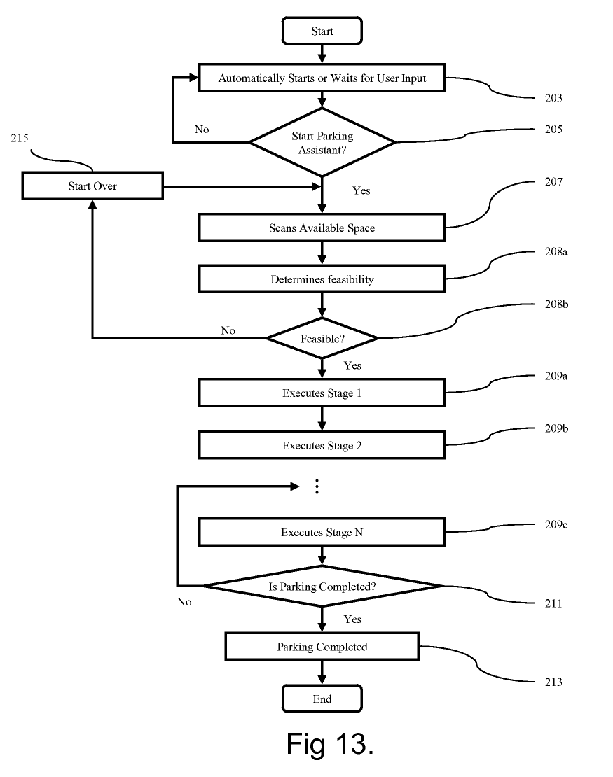

Referring to FIG. 13, a flow chart is shown for the steps of a method for parking assistance according to an embodiment of the invention. The device may be powered on at step 201, which may coincide with power-on of the vehicle with this device installed on.

In step 203, the Central Processing Module 21 may automatically activate the park assist mode when certain conditions are met such as when the vehicle moves at a low speed after reaching proximity of destination. For example, such determination can be made based on GPS navigation information. If the vehicle with the invention installed starts to move at a slow speed after reaching proximity of destination or street parking areas, the driver is likely to be looking for a parking space. In another embodiment, the driver may activate the device manually when it is appropriate to do so. When either of the conditions is met at step 205, the Central Processing Module 21 directs the parking operation to step 207; otherwise the parking operation goes back to step 203 and waits for activation signal.

In step 207, the Central Processing Module 21 scans the area for a suitable parking space. The determination is based on the physical dimensions and characteristics (such as overall length, width, wheel base, and turning radius) of the vehicle as well as preferences (such as number of turns the driver is willing to perform) provided by the driver. The user or driver will be able to choose whether a minimum number of turning is desired at the expense of potentially not being able to park into a tight space. The user may instead choose the ability to park into the smallest parking space at the expense of having to turn the steering wheel and move the vehicle back and forth many times. If a determination is made for a suitable parking space (in other words, feasibility is tested and confirmed at steps 208a and 208b), then the driver is instructed to move the vehicle to a starting position.

In step 209a, the driver is instructed to turn the steering wheel to a certain target steering angle, and when the target angle is reached, the driver is instructed to move backward or forward, depending on the sequence. The process may repeat as few as two times or as many times as necessary to park the vehicle per the driver's preference settings, eventually reaching step 209c.

In step 211, if the parking is deemed complete, a HMI informs the driver of the completion of parking and the parking operation proceeds to step 213. If a determination is made that parking is not complete, the vehicle returns to one of the previous steps and instructs the driver to move accordingly.

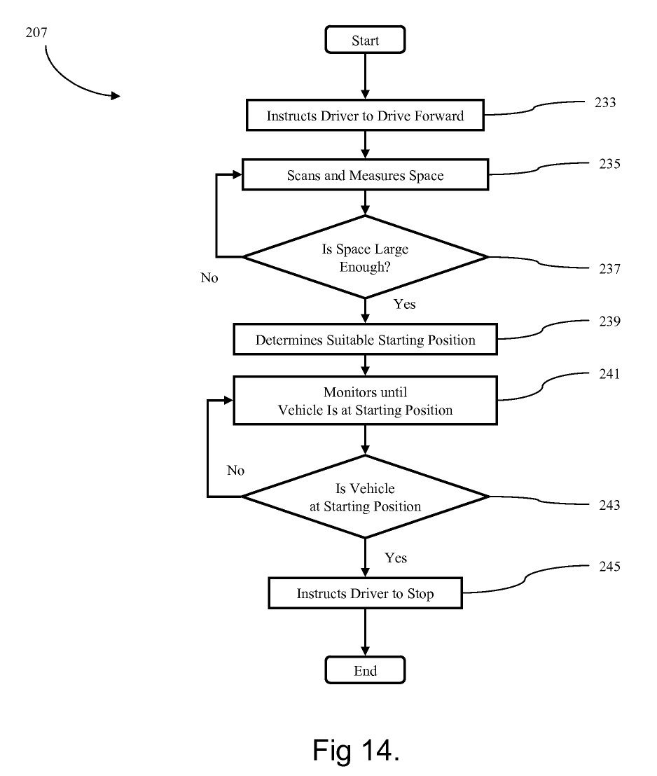

Referring to FIG. 14, a detailed flow chart is shown for the steps of a method of an overall sensing module and algorithm according to an embodiment of the invention. When the algorithm reaches step 207, the present invention instructs the driver to pull forward in step 233. In step 235, the device scans the area nearby, looking for a suitable parking space. Alternatively, the device may use information on the relative position of the parked vehicles based on other measurements such as GPS coordinates.

In step 237, a determination is made whether space scanned is large enough for parking of the vehicle. If a determination is made that space is large enough for parking, the Central Processing Module 21 calculates a starting position in step 239 based on the vehicle's location relative to parked vehicles and other vehicular and environmental parameters. If a determination is made that space is not large enough for parking, the device goes back to step 235.

In step 241, the device monitors the vehicle's movement. A determination is made in step 243 whether the vehicle is at the staring position. If a determination is made that the vehicle is at the starting position, the driver is instructed to stop in step 245. If a determination is made that the vehicle is not at the starting position, the Central Processing Module directs the process to return to step 241.

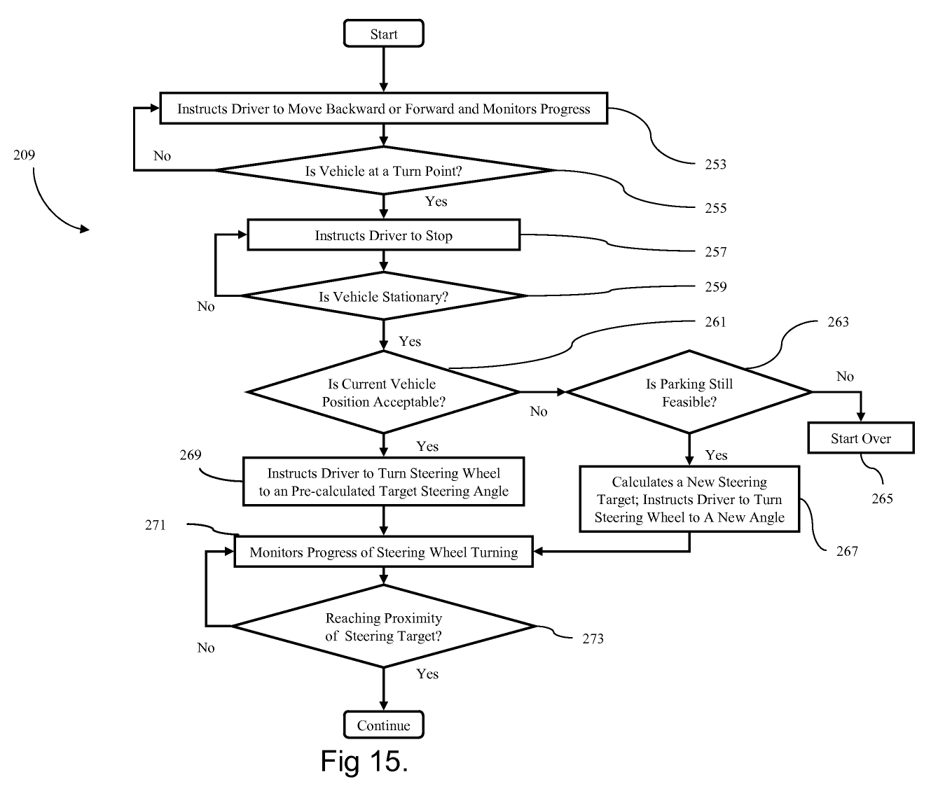

Referring to FIG. 15, a detailed flow chart is shown for the steps of a method for an execution stage according to an embodiment of the invention.

In step 253, the driver is instructed to move backward or forward and its progress is monitored.

In step 255, a determination is made whether the vehicle is at a turn point where turning of the steering wheel is necessary. If a determination is made that the vehicle is not at a turn point, the device returns to step 253. If a determination is made that the vehicle is at a turn point, the driver is instructed to stop in step 257.

In step 259, a determination is made whether the vehicle has stopped. Such determination may be based on the wheel speed sensor measurements, GPS measurements or other means of measuring speed of the vehicle. If a determination is made that the vehicle is still moving, the method returns to step 257 and instructs the driver to stop. If a determination is made that the vehicle has stopped, the method proceed to step 261.

In step 261, a determination is made whether the vehicle stop position is within an error bound so that vehicle can be still parked into the parking space with previously calculated parking path instructions. If a determination is made that the vehicle can still be parked with previously calculated parking path instructions, then the method proceeds to step 269. If a determination is made that the vehicle cannot be parked with previously calculated parking path instructions, the method proceeds to step 263.

In step 263, a determination is made whether the vehicle can still be parked into the space determined in step 207 from the current position. If a determination is made that the vehicle can still be parked or maneuvered into the parking space from step 207, then the method proceeds to step 267. If a determination is made that the vehicle cannot be parked into the parking space, given characteristics of the vehicle or preferences of the driver, the method proceeds to step 265.

In step 265, the method returns to step 215 in FIG. 13, and starts over.

In step 267, the method calculates a new set of parking maneuvers and instructs the driver to turn the steering wheel to another angle.

In step 269, the method instructs the driver to turn the steering wheel to a constant target steering position that is calculated based on a previously determined parking space and parking path.

In step 271, the method monitors the progress of turning of the steering wheel.

In step 273, a determination is made whether the angle of the steering is within the acceptable range of the target angle. If a determination is made that the current steering wheel angle is not within the acceptable range of the target angle, the methods returns to step 271. If a determination is made that the current steering wheel angle is within the acceptable range of the target angle, the methods proceeds to the next step.

In one embodiment of the parking instruction generation, an algorithm or multiple algorithms may reside in the Central Processing Module 21 that includes a vehicle model in the Vehicle Model Module 49 and optimized Path Generation Module 53. The Vehicle Model Module predicts where the vehicle might be in the future based on the current location and other measurable quantities such as steering wheel angles and distance traveled. A vehicle model contains characteristics of the particular vehicle and includes vehicle length, width, turning radius and other vehicle specific information.

In the embodiment, the Path Generation Module 53 may execute an optimization routine that optimizes the discrete steering instructions, based on the theory of convex optimization. The current invention utilizing this particular algorithm provides a unique advantage in that, given the current information on the vehicle location relative to the parked vehicles, the orientation of the vehicle relative to the parked vehicles, and the vehicle's mechanical characteristics such as turning radius, the size of available parking space, the feasibility of parking success is determined beforehand. In other words, given the conditions mentioned above, the algorithm can inform the driver whether the vehicle can be parked into the attempted space. This feature is advantageous since the drive can avoid unsuccessful attempts in parking when the parking is not possible at all.

Once the feasibility of parking into a particular space is confirmed, the algorithm will compute the optimal, discrete steering wheel instructions that are the best solution according to the conditions provided by the driver or default settings. For example, the driver may choose the maximum number of steering instructions (for example, 3 turns). In such a case, the driver may have to give up the particular parking space if it is too small, since a tight space may require more steering turns than the driver requested. On the other hand, the driver may choose the option of maximum parking feasibility which may result in many steps of steering instructions. In this case, while the driver has to turn the steering wheel many times, the driver would be able to park the vehicle in the smallest parking space that is feasible to park, given the vehicle conditions such as vehicle length, width and turning radius, etc.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

We claim:

1. A method of providing assistance to a driver for parking a vehicle comprising:
detecting a space and a location of the vehicle for vehicle parking;
determining a feasibility for parking the vehicle into the space based on the space;
calculating a parking path based on the space and the location;
generating a constant target position of a steering wheel based on the parking path;
generating a first human machine interface (HMI) signal that instructs the driver to turn the steering wheel based on the target position, wherein the first HMI signal is generated when the vehicle is not moving;
monitoring a steering wheel angle of the vehicle comprising:
comparing the steering wheel angle with the constant target position, and
detecting that the steering wheel angle reaches a proximity of the target position;
generating a second HMI signal that instructs the driver to hold the steering wheel, wherein the second HMI signal is generated when the steering wheel angle has reached the proximity of the target position;
generating a vehicle motion command after the steering wheel angle is held steadily according to the second HMI signal; and
generating a third HMI signal based on the vehicle motion command.

2. The method as in claim 1 further comprising generating a plurality of constant target positions of the steering wheel;

3. The method as in claim 2, wherein the number of the plurality of constant target positions is determined based on a driver's preference for parking difficulty.

4. The method as in claim 1, wherein the constant target position has a magnitude less than a magnitude of full-lock position of the steering wheel.

5. The method as in claim 1, wherein the constant target position has a magnitude equal to a magnitude of full-lock position of the steering wheel.

6. The method as in claim 1, wherein the HMI signal is an audible signal.

7. The method as in claim 1, wherein the HMI signal is a visual signal.

8. The method as in claim 1, wherein the HMI signal is a tactile feedback signal.

9. The method as in claim 8, wherein the HMI signal is a vibration signal on the steering wheel.

10. The method as in claim 1 further comprising:
generating an upper bound of the target position;
generating a lower bound of the target position; and
determining the proximity of the target position based on the upper bound and the lower bound.

11. The method as in claim 1, wherein the parking path includes a turn point where turning of the steering wheel is necessary, and
wherein the driver is instructed to stop when the vehicle approaches the turn point.

12. The method as in claim 1 further comprising:
monitoring a rear object while backing the vehicle;
monitoring a front object while moving the vehicle forward;
generating a warning signal when the rear object is within a first predetermined distance from the vehicle; and
generating a warning signal when the front object is within a second predetermined distance from the vehicle.

13. The method as in claim 1, wherein the detecting of the space and the location comprises processing of an ultrasonic signal.

14. The parking assist system of claim 1 wherein the vehicle motion command comprises a first instruction to move the vehicle backward.

15. The parking assist system of claim 1 wherein the vehicle motion command comprises a second instruction to stop the vehicle.

16. The parking assist system of claim 1 wherein the vehicle motion command comprises a third instruction to move the vehicle forward.

17. A parking assist system for providing parking instructions to a driver of a vehicle comprising:
a central processing module that
receives vehicle signals,
detects a space for parking,
determines a relative position between the space and the vehicle based on the vehicle signals, and
a space determining module that determines a feasibility of whether the space is large enough for parking;
a parking path calculating module that
computes a parking path based on the feasibility, the size of the space and the relative position,
generates a target steering position command based on the parking path, wherein the target steering position command is piecewise constant, and
generates a vehicle motion command based on a steering motion status of a steering wheel;
a progress monitoring module that
monitors a steering wheel position and the target steering position command and determines whether the steering wheel position is within a predetermined error bound of the target steering position command,
monitors a steering wheel motion to determine whether the steering wheel is held steadily, and
generate the steering motion status based on the monitored steering wheel position and the monitored steering wheel motion; and
a user interface control module that
generates a first human-machine interface (HMI) signal based on the piecewise constant target steering position command,
generates a second HMI signal when the steering wheel position is within the error bound of the target steering position command, and
generates a third HMI signal based on the vehicle motion command.

18. The parking assist system of claim 17, wherein the HMI module further receives a driver's input of a preference.

19. The parking assist system of claim 18, wherein the target steering position command is generated based on the preference.

20. The parking assist system of claim 17 further comprising a wireless receiver that receives the vehicle signals.

21. The parking assist system of claim 17 further comprising a wireless transmitter that transmits a human machine interface signal to a wireless user interface device.

22. The parking assist system of claim 21, wherein the user interface device is an audio device.

23. The parking assist system of claim 21, wherein the user interface device is a video device.

24. The parking assist system of claim 21, wherein the user interface device is a tactile feedback device.

25. The parking assist system of claim 24, wherein the tactile feedback device is a vibrational device connected to the steering wheel.

26. The parking assist system of claim 17 further comprising a vehicle signal interface device that is electrically connected to a vehicle signal bus and the central processing module, and receives the vehicle signals from the vehicle signal bus for the central processing module.

27. The parking assist system of claim 17, further comprising sensor devices that generate the vehicle signals, said sensor devices include:
a steering wheel angle sensor device that senses an angle of the steering wheel;
a wheel speed sensor device that senses
a speed of the vehicle, and
a distance of vehicle movement; and
a proximity sensor device that senses an object near the vehicle.

28. The parking assist system of claim 27 wherein the proximity sensor is an ultrasonic sensor.

29. The parking assist system of claim 17 wherein the steering motion status is reset when the steering wheel is held steadily and the steering wheel position is within a predetermined error bound of the target steering position command.

30. The parking assist system of claim 17 wherein the vehicle motion command comprises a first instruction to move the vehicle backward.

31. The parking assist system of claim 17 wherein the vehicle motion command comprises a second instruction to stop the vehicle.

32. The parking assist system of claim 17 wherein the vehicle motion command comprises a third instruction to move the vehicle forward.

33. The parking assist system of claim 17 wherein the second HMI signal comprises a fourth instruction to hold the steering wheel steadily.
